(19) United States
(12) Patent Application Publication
(10) Pub. No.: US 2005/0149869 A1
(43) Pub. Date: Jul. 7, 2005

(54) Clinical trial monitoring system and method

(75) Inventors: Bruce A. Kehr, Potomac, MD (US); Robert H. Benson, Bethesda, MD (US)

Correspondence Address: Elizabeth E. Kim;McDermott, Will & Emery, 28 State Street, Boston, MA, 02109, US

(73) Assignee: InforMedix, Inc.

(21) Appl. No.: 10/887,741

(22) Filed: Jul. 9, 2004

Related U.S. Application Data
(60) Provisional application No. 60/486,475, filed on Jul. 11, 2003.

(51) Int. Cl. G06F 3/00

(52) U.S. Cl. 715/700

(57) ABSTRACT

A method and system are presented for monitoring the performance of a clinical trial, and the adherence of trial participants to a protocol for the clinical trial. A plurality of templates are provided, which can be populated with protocol data can be entered that relate to behavioral elements of the protocol. The populated templates are downloaded to a plurality of remote devices. The remote devices generate, upon receipt of the templates populated with protocol data, prompting messages that prompt participants whether protocol elements have been performed, and that request performance data relating to any actual performance of the protocol elements. Based on the performance data, reports are periodically generated that compare actual performance of the protocol elements with expected or desired performance of the protocol elements.

### CROSS REFERENCE TO RELATED APPLICATIONS

This application claims the benefit of priority under 35 U.S.C. §119(e) from co-pending, commonly owned U.S. provisional patent application, Ser. No. 60/486,475, filed on Jul. 11, 2003, and entitled “Clinical Drug Trial Pacing and Monitoring System”. The entire content of this provisional application is incorporated herein by reference.

### BACKGROUND

In order to develop a new drug and introduce it into the market, one or more clinical drug trials are usually required. The number of clinical trials that are being conducted continues to increase rapidly. According to one estimate, pharmaceutical and/or biotechnology companies had over 4,000 new drugs in the development pipeline in 2002, and more than 40,000 clinical trials were carried out to test these drugs. It has been estimated that between about 4 million to about 6 million people take part in clinical trials each year. This number is projected to grow at double-digit rates during the next decade, in view of new research and development breakthroughs that are expected to take place.

The total cost associated with developing and introducing a new drug to the market can be staggering. One published study estimated the average total cost to be over $800 million. Unfortunately, clinical drug trials are increasing in cost and complexity, placing increased demands on patient participants and researchers, as well as on their clinical coordinators. Trials are taking longer to complete, and new drug approvals are decreasing.

In the pre-market phase, the goals of a clinical trial may include studying the safety and efficacy of new drug compound as rapidly and rigorously as possible; proving drug claims by rapidly collecting data to meet clinical end points; and bringing the new drug to market as quickly as possible. In the case of a drug that is already on the market, the goals of the clinical trial may include proving new drug claims as rapidly as possible.

Ideally, a clinical trial protocol should be strictly adhered to, when conducting clinical trials. Organizing and carrying out complex trial protocols can be very challenging, however. A clinical trial typically goes through four well-defined phases, each of which requires researchers to collect and analyze significant amounts of patient-generated data. To ensure accuracy of the results of the clinical trial, considerable time must be spent in acquiring and managing the data. During acquisition of the data, patients and researchers must successfully adhere to a strictly defined clinical protocol, which typically includes many behavioral steps and tasks to be performed over prolonged periods of time.

Adhering to a strict protocol is a daunting task, however. As just one illustrative example, behavioral elements that need to be perform by patients and clinical researchers, in an exemplary clinical trial, may include the following tasks or events: 1) “patient visits the study site range, from every week to every 6-8 weeks, depending upon the disease type and the phase of the clinical trial;” 2) “at each visit, the clinical research coordinator and principle investigator carry out a complex sequence of behaviors, including but not limited to patient queries, history, physical exam, and laboratory evaluation.” The entire sequence of tasks or behavioral events should take place at a predefined frequency and with complete accuracy, something which in practice is very difficult to achieve. The data collection activities performed by clinical research coordinators and physician investigators tend to be prone to inaccuracies and omissions.

Significant costs can be incurred during each phase of a clinical trial. Key cost elements related to clinical trials may include patient recruitment, patient retention, acquisition of patient compliance and response data, assembly and management of the data, and analysis and reporting of the results in accordance with Food and Drug Administration (FDA) requirements. In particular, patient recruitment has been cited in one study as representing one of the largest cost components in a clinical trial. According to the study, pharmaceutical and biotechnology companies are experiencing difficulty in maintaining enrollment in clinical trials, and keeping patients compliant to the prescribed drug regimen and other elements of clinical trial protocols. More than 20% of patients “fall off” during clinical trials, failing to complete the trial for various reasons. Retaining trial patients would thus save time, money, and potentially the trial itself.

At present, the sequence of events or behavioral elements, which in their totality make up the trial protocol, tend to be carried out in a fragmented process that may take up to about ten years to complete. As a whole the clinical trial process tends to be labor-intensive and error-prone, resulting in poor data quality, less time for scientific studies, and longer time-to-market for the new drugs being studied.

Current approaches to accelerate time-to-market and to save costs in clinical trials include a variety of electronic data capture (EDC) technologies and electronic patient diaries (EPD). While these methods represent advances over paper and pencil data recording methods, they lack the ability to organize the entire trial workflow process, and fail to prompt and record the stakeholder behaviors, as is necessary in order to promote strict adherence to a trial protocol.

### SUMMARY

A system and method are described for monitoring clinical trial performance and encouraging adherence to a trial protocol by trial participants, by prompting for specific behaviors at specific times, recording performance data relating to actual performance of protocol elements that were adhered to, and comparing actual behaviors to desired behaviors. The method and system described below can simplify the monitoring of performance of trial protocol elements by the participants, and can substantially accelerate the progress of the clinical trial.

A method of monitoring clinical trial performance includes creating one or more templates and storing the templates in a database. The templates include data fields that can be filled by entering protocol data therein. The protocol data provide information about one or more elements pf a protocol for the clinical trial. The templates that have been filled with protocol data are converted into configuration files, after which they are downloaded from the database to one or more remote devices via a network.

The method includes prompting for the performance of at least one protocol element, and requesting performance data that contain information relating to any actual performance of one or more of the protocol elements. The performance data received at the remote devices are uploaded onto the database. The method further includes generating reports that compare the actual adherence to the protocol elements, as shown by the performance data, versus desired adherence to the protocol elements, as shown by the protocol data.

A system for monitoring performance of a clinical trial includes a database configured to store therein a plurality of templates that include data fields which can be filled by entering protocol data. The database is linked to one or more remote devices through a communications network. A controller is configured to control access to the database, and to control communications between the database and the remote devices over the network.

The controller causes the templates to be downloaded over the network to the remote devices, when the templates have been filled with at least some protocol data. The remote devices are programmed to generate, upon receipt of the populated templates, one or more prompt signals that prompt for performance of one or more protocol elements in accordance with the protocol data, and that request performance data relating to any actual performance of the protocol elements. The controller is further configured to upload the performance data from the remote devices and to store the performance data in the database.

A machine-readable medium has stored therein instructions that, when executed by a computer, cause the computer to: create a plurality of templates and store the templates in a database, the templates including data fields for allowing entries of protocol data; enter the protocol data into the templates, and downloading the filled templates from the database onto at least one remote device via a network, so that in response the remote devices generate and display prompt signals prompting for one or more protocol elements, and requesting performance data relating to any actual performance of the protocol elements; and to upload the performance data from the remote device onto the database, and store the performance data in the database.

A remote monitoring apparatus for monitoring performance of a clinical trial includes means for communicating with a remote database having stored therein a plurality of templates that include data fields into which protocol data can be entered. The remote monitoring apparatus further includes a memory, a display, an input device; and a controller configured to control access to the memory, to control display of messages on the display, and to control communications with the remote database. The memory stores a computer program which is executable by the controller to: download the filled templates from the remote database; generate prompt messages; request performance data; display the prompt messages on the display; and record and store in the memory any receive performance data.

### BRIEF DESCRIPTION OF THE DRAWINGS

FIG. 1 illustrates a schematic flow chart that illustrates a method of monitoring the performance of a clinical trial, in accordance with one embodiment.

FIG. 2 schematically illustrates a system for monitoring clinical trial performance, in accordance with one embodiment.

FIG. 3 illustrates an exemplary template into which protocol data have been entered, and that has been converted into a configuration file.

FIG. 4 provides an exemplary table of protocol elements, from which protocol data can be generated that describe each protocol element, and which can be entered into templates that have been stored in memory.

FIGS. 5A and 5B illustrate the first and second pages, respectively, of an exemplary two-page report generated by analyzing performance data received from one or more remote devices.

### DETAILED DESCRIPTION

A system and method are presented for monitoring clinical trial performance by prompting for the performance of protocol elements, recording behavioral events and actual performance data, and comparing actual behaviors to desired behaviors. The trial monitoring system described below divides up a complex trial protocol into constituent protocol elements or behavioral elements, and encourages each participant to strictly adhere to the trial protocol by performing the correct expected behaviors at the correct times.

The system and method described below can be implemented by an apparatus for performing the operations that are described. The apparatus may be specially constructed for the required purposes, or may include a general purpose computer that is selectively activated or reconfigured by a computer program stored in the computer. Such a computer program may be stored in a computer readable storage medium.

A computer-readable medium is any article of manufacture that contains data that can be read by a computer or a carrier wave signal carrying data that can be read by a computer. The computer-readable medium may include magnetic media, such as floppy disks, flexible disks, hard disks, reel-to-reel tape, cartridge tape, cassette tape, read-only memories (ROMs), random access memories (RAMs), and magnetic cards; optical media, such as optical disks, CD-ROMs, writable compact disk, EPROMs, EEPROMs, and optical cards; magneto-optical media, such as magnetic-optical disks; paper media, such as punched cards and paper tape; or any type of media suitable for storing electronic instructions, and each coupled to a computer system bus. The computer-readable instructions used to operate the trial performance monitoring system described below may also be distributed on a carrier wave signal received through a network, wireless network, or modem, including radio-frequency signals and infrared signals.

The method and system described below can be implemented in distributed computing environments where tasks are performed by remote processing devices that are linked through a communications network. The methods described herein are not inherently related, however, to any particular computer or other apparatus. Various general purpose systems may be used with programs in accordance with the teachings herein, or it may prove convenient to construct more specialized apparatus to perform the required method. For example, any of the methods according to the present invention can be implemented in hard-wired circuitry, by programming a general purpose processor or by any combination of hardware and software. One of skill in the art will appreciate that a variety of computer system configurations can be used, including but not limited to hand-held devices, multiprocessor systems, microprocessor-based or programmable consumer electronics, network PCs, minicomputers, and mainframe computers.

The methods described below may be implemented using computer software. If written in a programming language conforming to a recognized standard, sequences of instructions designed to implement the methods can be compiled for execution on a variety of hardware platforms and for interface to a variety of operating systems. In addition, the methods and systems discussed below are not described with reference to any particular programming language. It will be appreciated that a variety of programming languages may be used to implement the teachings as described herein.

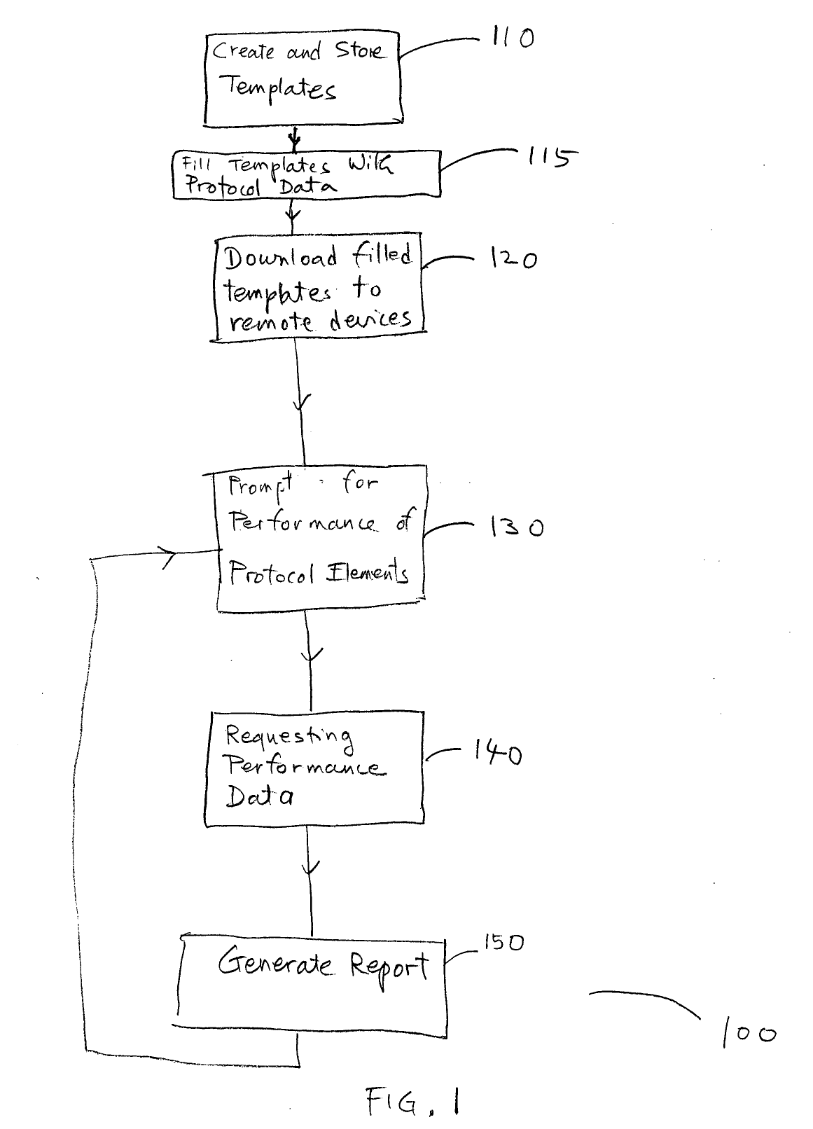

FIG. 1 illustrates a schematic flow chart that illustrates a method 100 of monitoring the performance of a clinical trial, in accordance with one embodiment. In overview, the method 100 is directed to monitoring the performance of a clinical trial to assess the degree of adherence to a predefined protocol for the clinical trial. In step 110, a plurality of templates are created, and stored in a database. Each template includes a plurality of data fields, for example labeled fields, into which a finite set of protocol data can be entered, where the protocol data contain information relating to one or more elements of the trial protocol. These protocol elements are behavioral elements, namely expected behaviors and expected rates of behaviors. Step 110 thus involves breaking down the clinical trial protocol into a plurality of protocol elements, i.e. reducing the complex trial protocol to data that reside in templates stored in a database.

In step 115, the templates are populated by entering at least some protocol data into the template data fields. Preferably, protocol data relating to substantially the entire protocol are entered into the templates. In step 120, the populated templates are downloaded from the database onto one or more remote devices. Typically, the implementation of the trial protocol requires a large number of remote devices, provided for use by at least some of the participants of the clinical trial, e.g. the clinician researchers and the study monitors. In one embodiment, the populated templates are first converted into configuration files, then the configuration files are communicated to the remote devices. The configuration files are stored in the remote devices.

In step 130, the participants of the protocol are prompted, preferably at predefined intervals, for specific behaviors, i.e. for the performance of one or more protocol elements. In other words, the participants are asked whether they performed their expected portions of the protocol, or whether they performed the protocol elements expected of them, and may be urged to follow their respective portions of the clinical trial protocol. In one embodiment, one or more prompt messages are generated and displayed on the screens of the remote devices, preferably at predetermined time intervals. In one embodiment, selecting an icon displayed on the screen provides a response, namely the response that the behavior has been performed at a specific date and time.

In step 140, participants are asked to provide performance data that contain information regarding whether or not one or more protocol elements have been performed, i.e. information regarding behavioral adherence. Such requests for performance data may be made by causing a list of possible responses to one or more queries to be displayed on a screen. Selecting an answer displayed on the screen may provide a response related to the performance or lack of performance of the behavior.

In step 150, reports are generated that indicate, inter alia: the rate of and degree of behavioral adherence to the protocol, or lack thereof, and progress in conducting and completing the clinical trial. These reports provide the capability for prompt interventions with the researchers and/or study monitors, to ensure that the clinical trial is fully implemented at the expected rate, and processed and concluded as efficiently as possible. In one embodiment, these reports are generated at predetermined time intervals, for example on a daily or more frequent basis.

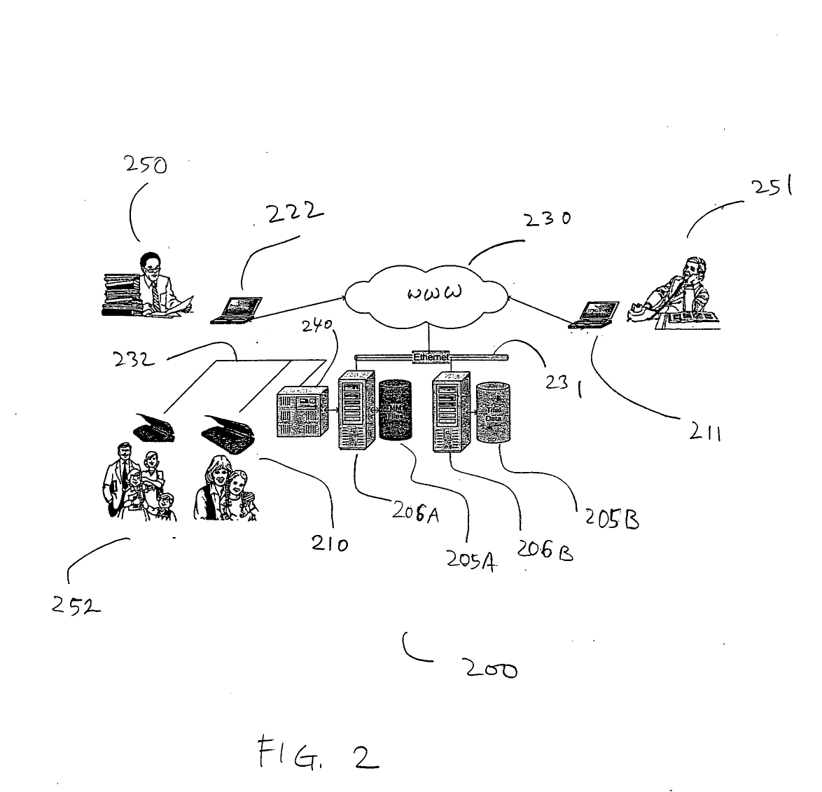

FIG. 2 schematically illustrates a system 200 for monitoring clinical trial performance, in accordance with one embodiment. In overview, the system 200 includes: databases 205 and 206; controllers 208 and 209 which control access to each database; and a plurality of remote devices (shown in FIG. 2 as 210, 211, and 212, respectively), only three of which are illustrated. The databases 205 and 206 and their controllers 208 and 209 are linked to the remote devices 210, 211, and 212, via one or more communications links or networks, e.g. the Internet 230, the Ethernet 231, or the telephone line 232. The remote devices are provided for the use of trial participants. The trial participants may include, inter alia, researchers 250, sponsors 251, and patients 252.

In one embodiment, the databases 205 and 206 may be a standard ODBC compliant database, for example Oracle 9i. Each database stores and provides access to the templates, which are used to enter the protocol data, i.e. the expected behaviors of each of the stakeholders in the clinical, and the expected rates of performance of the behaviors. Each database also stores and provides access to the reports of stakeholder adherence. The databases may store the reports as a ratio or percentage of actual versus expected events.

The remote devices 210, 211, and 212 may be any monitoring device capable of communicating by modem, fax, phone line or wireless means to the database. These remote monitoring devices may include, but are not limited to: personal digital assistants (PDAs) such as the Palm Pilot, Ipaq, or Blackberry; mobile telephones; desktop or laptop PCs; or other computing device. Each remote device typically includes standard computer components, such as a memory, a display, and an input device, and can communicate with the remote databases 205 and 206 using communications means such as the modem pool 240. The remote devices are used to present behavioral prompt messages, and to record the adherence to the protocol.

In one embodiment, the memory in each remote device stores a computer program which is executable by the controller to: 1) download from a remote database one or more templates into which protocol data have been entered; 2) generate and display prompt messages that prompt for the performance of protocol elements, and that request performance data from the user of the remote device. The performance data provides information as to whether the user actually performed any portion or element of the protocol.

The remote devices may be used interactively by the protocol participants, who may include but are not limited to, patients, clinical research coordinators, physician-investigators, and study monitors. In particular, the remote devices are used to record the performance data, which is essential to the clinical trial, and which is defined by the trial protocol design. The performance data recorded by the devices are transmitted to at least one remote database (e.g. 205 and/or 206), which then store the data. The database and the remote devices then synchronize, so that the devices can be provided with any necessary updates to the protocol, thereby modifying the prompted behaviors and recorded data.

The templates stored in the databases include data fields to be filled with protocol data that contain information regarding the protocol elements. The databases may contain business logic rules, which convert the protocol data from the templates into configuration files to be downloaded into the remote devices.

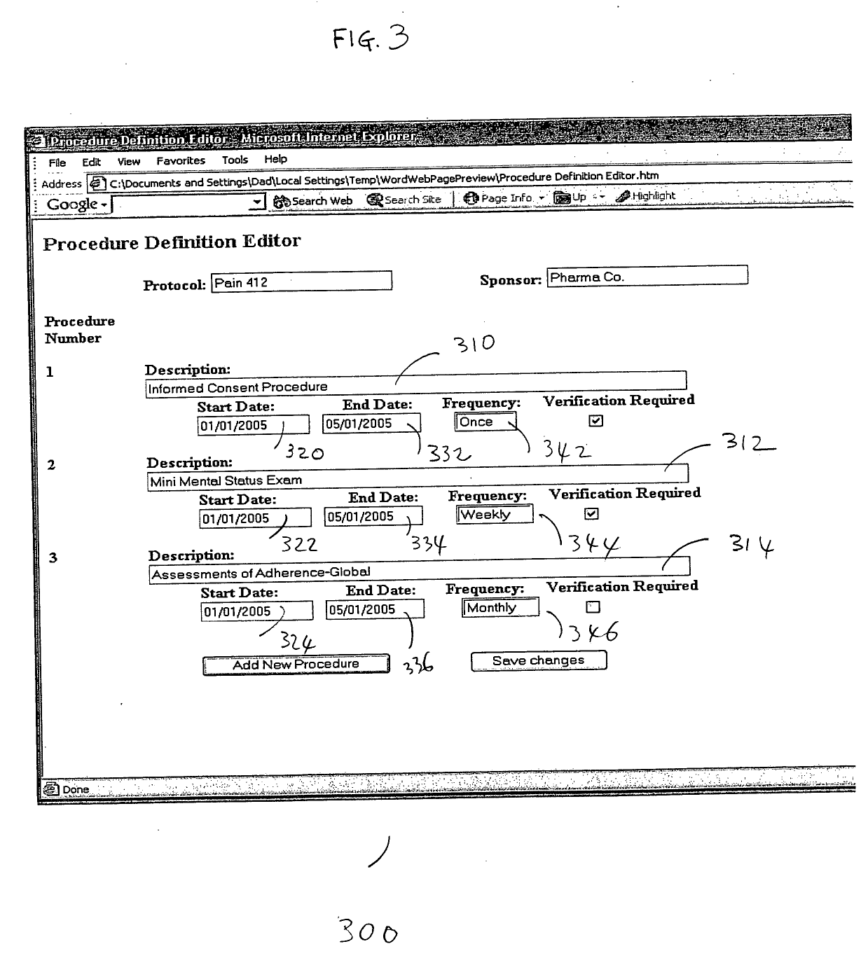

FIG. 3 illustrates an exemplary template into which protocol data have been entered, and that has been converted into a configuration file. As seen from FIG. 3, the template includes a number of labeled data fields, where each labeled data field can be filled by entering some protocol data. For example, the labeled data field 320 provides for entry of protocol data that provide information regarding the start date of the protocol element “informed consent procedure.” The labeled data fields 322 and 324 provides for entry of protocol data relating to the start dates of protocol elements “mini mental status exam” and “assessments of adherence—global.” Similarly, the labeled fields 332, 334, and 336 provide for entry of protocol data relating to the end dates of the respective protocol elements. Likewise, the labeled fields 342, 344, and 346 relate to the frequencies at which the respective protocol elements are expected to be completed by.

The plurality of templates, which are stored in the databases 205 and 206 and which may form a template array, provide for the entering of one or more of the behavioral protocol elements of the clinical trial protocol, alone or in combination. These behavioral protocol elements include, but are not limited to: identification and recruitment of clinical sites, and training the research staffs in the protocol design and implementation; recruiting, interviewing, selecting or rejecting potential staff for participation, enrolling, treating, and monitoring; and recording data about staff performance at the sites, and possibly in the patient homes, analysis and submission of the data to the FDA; and recording of laboratory values; physiologic measures; radiographic and other imaging test results; patient history information, administrative data, and physical examination data; enrollment data; and any other data to be captured from patients involved in the clinical trial.

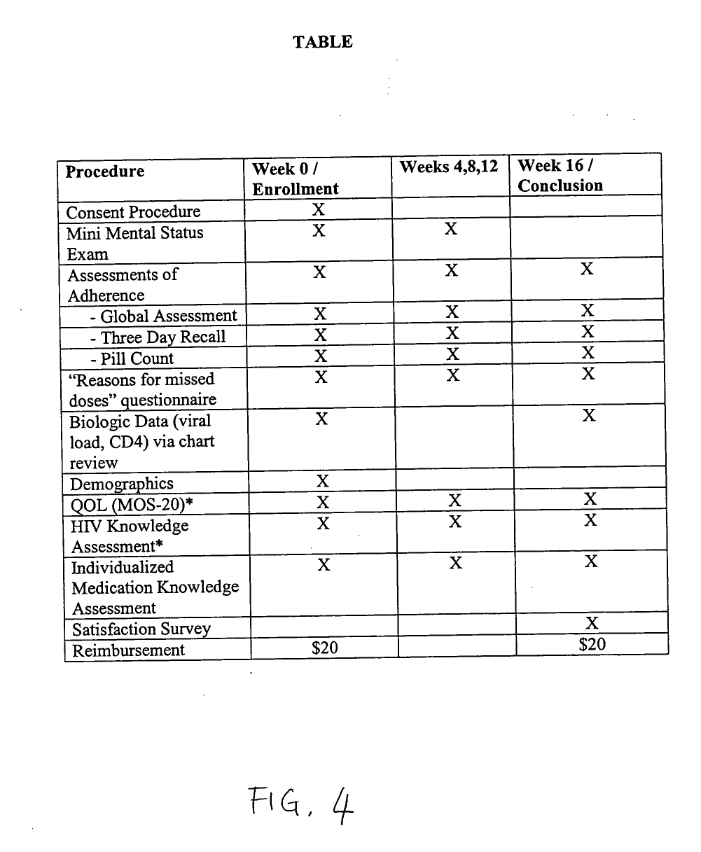

FIG. 4 shows a table of exemplary protocol elements, from which protocol data can be generated that provide information about the protocol elements, and which can be entered into templates that have been stored in memory. In other words, FIG. 4 provides a sample table of clinical trial site-based behavioral elements, that may be reduced to templates in a database, and that define the expected rates of prompted and recorded events for clinical research coordinators and physician-investigators.

As seen from FIG. 4, the protocol behavioral elements may include, e.g., consent procedure; mental protocol adherence assessment; questionnaire regarding reasons for missed doses; biologic data via patient chart review; demographics; QOL; HIV knowledge assessment; individualized medication knowledge assessment; satisfaction status exam; survey; and reimbursement. It should be appreciated that a wide range of other types of protocol behavioral elements may be entered into the templates stored in the remote databases, depending e.g. on the type of drug and the type and severity of diseases.

The behavioral events that must be followed by the clinical research coordinator and physician researcher or investigator relates to prompted behaviors and recorded data at the clinical drug trial site that should occur at expected rates. As FIG. 4 shows, the behavioral procedures such as obtaining informed consent, performing certain types of exams and entering the results of the exams, laboratory tests performed and data entered regarding the results, radiological testing, questionnaires to be answered by patients and medical personnel, surveys, and other types of events.

An example of the type of study events that must be followed for an entire complex protocol, designed for HIV/AIDS patients in a clinical drug trial, is provided below. In overview, in this example the protocol elements for which prompting messages are generated, and performance data solicited and recorded, are the following: 1) assessment for inclusion into the study; 2) enrollment of the patients and their granting of informed consent; 3) baseline evaluation; 4) randomization of the patients; 5) patient instructions concerning the use of the Med-eMonitor;
6) interventions with the patient; 7) information regarding the control group; and 8) scheduling of follow up visits and outcome measures

The entire set of protocol data that contain complete information regarding the protocol elements described above are provided below.

1. Prompt and Record the Assessment for Inclusion Into the Study

Inclusion Criteria—Expected Rate of Three Patients Per Week Per Site at Ten Sites
1. Age 18-75 years
2. Documentation of HIV infection
3. CD4+ count>100
4. Taking a HAART regimen for at least two months HAART will be defined as three or more antiretroviral medications. For combination tablets (i.e. combivir, trizivir) the individual component antiretroviral agents will be counted (i.e. two and three, respectively)
5. Understands written and spoken English.
6. Access to working phone line at primary residence (cellular phone not sufficient). Telephone service must be adequate for Med-eMonitor communication [study coordinator will call telephone company at screening visit, with subject's permission, to review phone service and determine eligibility.

Exclusion Criteria
1. Unstable housing: Does not have permanent address, or anticipates moving within the next year.
2. Serious cognitive limitations (Mini Mental Status Exam <18)
3. Does not have a telephone at home
4. Telephone restrictions that do not allow for toll-free long-distance calling (i.e. restrictions placed on a line for credit issues). [Study coordinator will call telephone company during screening visit to confirm access to appropriate telephone service.]
5. Any factor that, in the opinion of the subject's HIV healthcare provider or study PI, would severely limit the potential subjects' ability to accurately comply with the project's intervention. |

The final determination of eligibility will be made by principal investigator.

2. Prompt and Record the Enrollment of the Patients and Their Granting of Informed Consent—Expected Rate of Two Patients Per Week Per Site—Ten Sites

Patients who meet inclusion criteria and do not meet exclusion criteria will be offered an opportunity to participate in the study. The research assistant will explain the study, and patients who agree to participate will be evaluated using the “Evaluation to Sign Consent Form.” This form has a series of questions:
1. Is the patient alert and able to communicate? (yes or no)
2. Express an adequate level of understanding in how to dispense medications from and refill the Med-eMonitor or other medication containing device.
3. Express an adequate level of understanding in how to respond to prompts and questions displayed on the Med-eMonitor screen.
4. Explain what to do if he/she decides that they no longer wish to participate in the study. Correct answers for this question will include: inform the research assistant; inform the Principle Investigator; or inform the treating clinician. The patient must understand that he/she can decide at any time, and with no negative consequences, to withdraw from the study.
5. Explain what to do if he/she is experiencing distress or discomfort. Correct answers for this question will include: inform the treating clinician; inform the research assistant; inform the Principle Investigator; come to the clinic where he/she is being treated; or come to the emergency room.

Patients who are unable to successfully complete all questions will be excluded from the study. Patients who are able to complete the questions will be asked to review the informed consent with the study coordinator and sign where appropriate. The project and informed consent will be approved by the Health Center's Institutional Review Board and General Clinical Research Center prior to the first subject recruitment.

Treatment

During the three-month study period, all patients will receive a HAART regimen as prescribed by their physician. The regimen can be changed by the clinician at any time as clinically indicated.

3. Prompt and Record The Baseline Evaluation—Expected Rate of Two Patients Per Week Per Site—Ten Sites

During the initial clinic visit, patients will have an evaluation consisting of the following components:
1. Confirm eligibility;
2. CD4+ count (obtained from chart review);
3. Viral load (obtained from chart review);
4. Demographic form, including history of illness and treatment;
5. Quality of Life Interview (MOS HIV-20) The MOS-20 was derived from the Medical Outcomes Study to assess health-related quality of life[27] and is widely used. It consists of 20 relatively simple patient-rated questions around health-related impairments in daily activities, illness concomitants (e.g. pain, malaise), and psychological states. The survey takes about 10 minutes to complete.
6. Self report on adherence
   a. Global self-report
   b. Seven-day medication event recall
7. Self-reported side effect checklist: This instrument involves Likert-scale ratings of patient-reported side effects.
8. A test of patient knowledge about the disease, including questions on interpreting a Viral Load and CD4 counts, reasons for treating the HIV virus, and the relationship of adherence to resistance.
9. Questionnaire assessing reasons for missed doses of HAART within the preceding 2 weeks.

10. A drug-regimen specific questionnaire will be given.

This series of questions will inquire about dosing frequency, food/empty stomach requirements, and reasons for taking a medication as well as other drug specific information that will be included in the informational display that is programmed into each medication display. [An example would be to assess knowledge of Crixivan (indinavir) to ascertain that it 1. is an antiviral drug (as opposed to a prophylactic antibiotic), 2. is a protease inhibitor, 3. should be taken on an empty stomach or light snack, 4. should be taken with plenty of daily hydration, and 5. should be dosed 2 pills every 8 hours]. Because different individuals may be prescribed differing doses of the same medication, dosing issues will refer directly to the individual patients dosing requirements as indicated on their prescription bottle. For example one subject's indinavir may be dosed at 400 mg #2 capsules three times daily, another subject may be prescribed 333 mg, #3 capsules three times daily, and yet another 400 mg #2 capsules twice daily with ritonavir for pharmacokinetic boosting.

4. Prompt and Record the Randomization of the Patients—Expected Rate of Two Patients Per Week Per Site—Ten Sites

Subjects will be randomized into one of two groups: Monitor group (n=25) and Control group (n=25). Subjects whose self-reported adherence is <95% will be randomized. Randomization will be in the form of a coin flip. Block randomization will be used to ensure that equal numbers subjects will be randomized to
1. HAART treatment with Standard-of-Care (Control group). OR
2. HAART treatment plus Med-eMonitor System (Monitor group);

5. Prompt and Record the Patient Instructions Concerning the Use of the Med-eMonitor—Expected Rate of Two Patients Per Week Per Site—Ten Sites

In addition to instructions, every patient will receive an appropriate manual. Participants will receive additional training and help every time their HAART regimen changes. During the initial session, patient who were randomized and assigned to the Monitor group will be instructed in the use of the Med-eMonitor System. Instruction will consist of the following:
1. Basic training about the device;
2. Training in how to fill the medication trays with medication;
3. Training in how to respond to medication alarms, open the compartment lids, and take the medication;
4. Training in how to learn about the disease and about medication side effects;
5. Training in how to answer the questions; and
6. Training in how to upload and download the information by placing the Med-eMonitor unit into its cradle, connecting the cradle to a standard telephone outlet, and plugging the patient's phone into the back of the cradle.

Patients in the control group will be asked to dose their medications using the same method they were using prior to entry into the study.

6. Prompt and Record the Interventions With the Patient—Expected Rate of Daily Patient Monitoring of All Enrolled Patients—Ten Sites

Subjects randomized to the intervention group will be issued a Med-eMonitor with instructions for use at home. The intervention has been designed to fully utilize the capabilities of the device and integrate the data into the patient's health care plan. Specifically, elements of the intervention will include the following:

1. Audio and Visual Prompting for Scheduled Dosing Events: The device will be programmed to beep at medication dosing times. A text message will be displayed, with an arrow indicating the medication that is due to be taken at that time. When the compartment with that medication is opened, the Med-eMonitor System will display to the patient or caregiver appropriate detailed instructions regarding self-administration of the medication, and record that the compartment was opened and closed. If a medication compartment is opened at an unscheduled time, a warning tone will sound and a warning message will be displayed indicating that it is not time to take the medication. It will query the patient whether they intend to take a medication, refill the compartment, or are just checking the medication supply.

2. Nurse Review of Adherence Data with Feedback: The study coordinator will review the Med-eMonitor uploaded adherence data from the internet site twice weekly to simulate when clinicians would be reasonably able to review the data. Feedback to the subject will be based on the adherence data generated as follows:

Conditional Feedback for Adherence Errors: The adherence data may reveal missed or inappropriate doses of medication. In the event that the study personnel identify a missed dose, this will prompt an “alert” message. The message will be supportive and positive, and will be accompanied by a single-item questionnaire requesting the patient to respond as to the most important reason why the most recent dose was missed. Since only subjects with baseline poor adherence will be eligible for the study, all subjects are expected to receive at least some additional feedback during the intervention period.

Daily feedback: Adherence data will be analyzed on a daily basis. A comment on the subject's adherence, regardless of degree of adherence, will be transmitted to the pill box in the form of an “alert” to be displayed on the LCD display. This review will be independent of the subject's HIV provider. This statement will be focused, brief, and designed to remind the subject that study personnel are reviewing the data. Text wording for this “alert” message will be supportive and positive, and will be guided by the results of focus-groups with HIV-infected people that have already been performed at the proposed study site. An example would be message might be “You took all of your pills on time this week. Great job!” or “You only took about half of your medicines this week,” followed by a supportive statement and phone numbers for professionals or study personnel.

7. Prompt and Record Information Regarding The Control Group—Expected Rate of Daily Patient Monitoring of All Enrolled Patients—Ten Sites

This group will approximate the community “standard of care”. Subjects randomized to the control group will continue dose their medications as per their usual method (i.e. from prescription bottles, pill boxes, etc). As even the perception of increased third party involvement may be sufficient to enforce adherence and thus skew data, study personnel will have limited interaction with the subject during the intervention period. Contact will be limited to scheduling of appointments and questions arising around follow-up.

8. Prompt and Record the Scheduling of Follow up Visits and Outcome Measures—Expected Rate of Daily Scheduling of Next Patient Visit for All Patients Seen That Day—Ten Sites

All patients will return to the clinic at month 3 from the date of the initial visit. All subjects will have explicit instructions to present with ALL prescription bottles. Intervention Subjects will be asked to bring their Med-eMonitors with them as well. Data to be gathered at this visit include the following:
1. Adherence data will be calculated for each subject in the following ways:
1a) Adherence to total pills taken to pills prescribed expressed as a percentage
1b) “Dose Time” adherence, i.e. adherence to dosing events within a 4-hour “window period” as described above.
2. Frequency of placing the Med-eMonitor in the cradle for data transfers (intervention group only)
3. Frequency of reviewing educational material (intervention group only)
4. Responses to the MOS-20 and HIV Knowledge Assessment tools
5. Biologic markers of HIV infection, including CD4 count and Viral Load (obtained from chart review)
6. A satisfaction scale will be administered to patients to determine their level of satisfaction with the use of the device. (intervention group)
7. Self-reported adherence.

In one embodiment, the method and system described above provide for reports that enable a company trial sponsor to monitor the global status of the clinical trial on a periodic basis, for example on a daily basis. These reports are reports of adherence to the protocol by protocol participants, who include clinical research coordinators, physician-researchers, and investigators. These reports may be provided at periodic time intervals, for example on a daily or more frequent basis. These reports may be multi-axial reports, which include actual versus targeted behaviors per unit of time as a percentage, in order to assist the sponsor in better monitoring the trial, and providing for targeted interventions to increase the efficiency of the trial process.

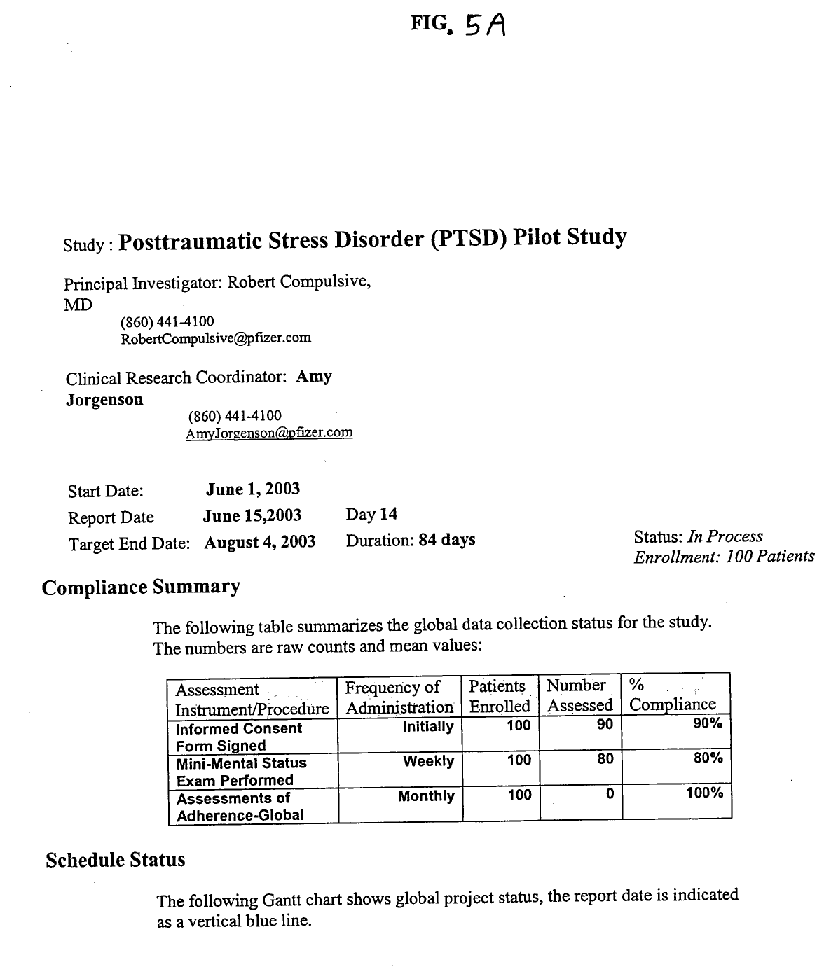

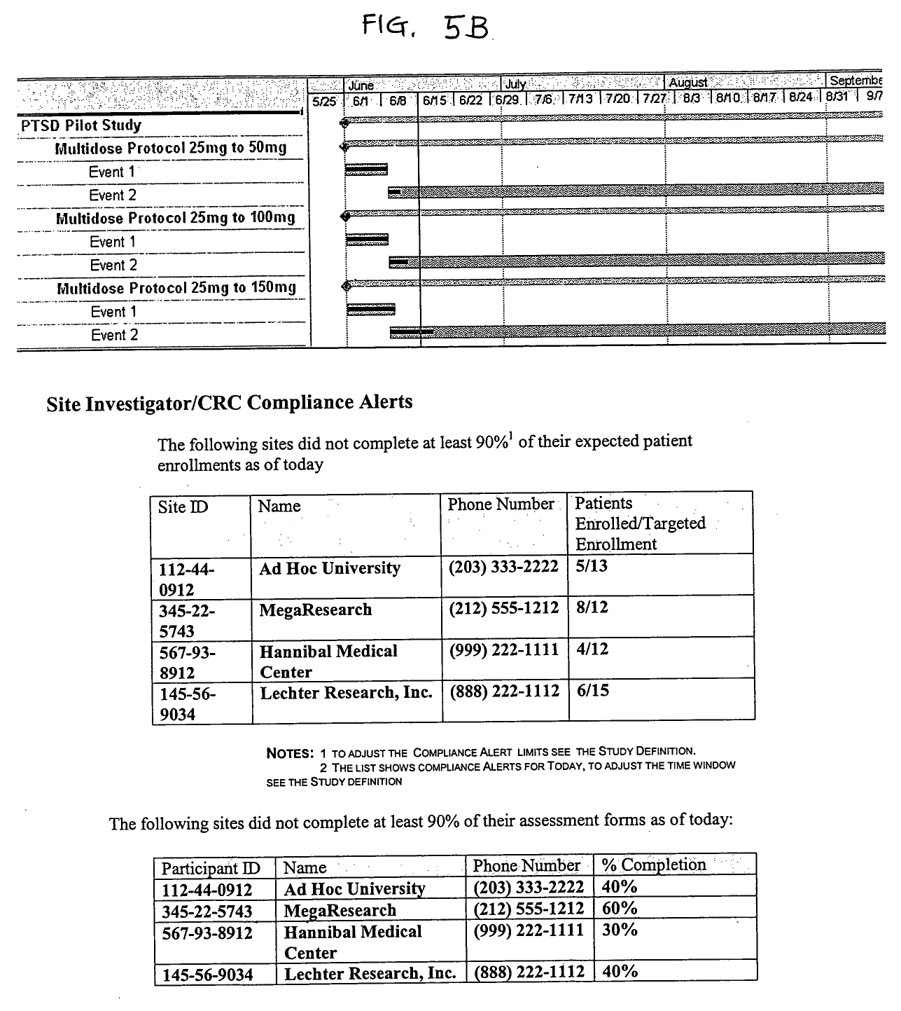

FIGS. 5A and 5B illustrate the first and second pages, respectively, of an exemplary two-page report that are generated using performance data received by one or more remote devices, and that describe the actual versus the desired adherence rates for the behavioral elements or events of the clinical trial protocol. As seen from FIG. 5A, the report includes, inter alia, a) a compliance summary, which tabulate the frequency of administration, the number of patients enrolled, the number of patients assessed, and the compliance percentages, for each of three protocol elements or behavioral steps. These three protocol elements are: signing informed consent form; performing mini-mental status exam; and global assessments of adherence.

As seen from FIGS. 5A and 5B, the report also includes a Gantt chart showing global project status of a PSD pilot study. As seen from FIG. 5B, the report also includes site investigator/CRC compliance alerts. In particular, these alerts list a plurality of sites which did not complete at least 90% of their expected patient enrollments as of the day of the report, and another plurality of sites which did not complete at least 90% of their assessment forms as of the date of the report.

In one embodiment, these protocol adherence reports can be assessed remotely, for example via the Internet, by study monitors and/or pharmaceutical company sponsors. Exceptions reports that indicate non-adherence can be provided by outbound messaging. These reports may include actual versus expected number of sites recruited and contracted, actual versus expected number of investigators trained, actual versus expected patients enrolled, actual versus expected patient protocol adherence, actual versus expected patient completion of the protocol, and rates of actual versus expected clinical data entered by the researchers and study coordinators. In one embodiment, these reports may be multi-axial reports that compare actual behaviors to desired behaviors on a multi-axial system that includes actual vs. desired elapsed time, and actual vs. desired behavioral event completion.

These reports permit early detection of problems in protocol implementation. In this way, prompt interventions with the researchers and/or study monitors are made possible, ensuring that the clinical trial is fully implemented at the expected rate, and is processed and concluded as efficiently as possible. It also enables a daily (or more frequent) audit of researcher performance to precisely determine the global status of the trial, and to provide a means of rewarding those who complete the expected behaviors within the expected time period.

In sum, a system and method have been described for monitoring, prompting, and recording the adherence to a trial protocol by the participants, and then presenting the actual versus expected results in a reporting format that enables rapid assessment of trial progress. The system and method described above provide for daily (or more frequent), enterprise-wide monitoring of the adherence, or the lack of adherence, to trial protocol elements by the researcher and/or study coordinator. In this way, rapid interventions can take place to correct problems and complete the trial in less time and at less cost. The system and method described above may even be used to provide reward incentives when actual performance equals or exceeds expected performance, thus increasing productivity and reducing time to clinical trial completion.

While the clinical trial monitoring system and method have been described and shown with reference to specific embodiments, it should be understood by those skilled in the art that various changes in form and detail may be made therein. Many other embodiments are possible.

Other embodiments are within the following claims.

1. A method of monitoring clinical trial performance, the method comprising:
creating one or more templates and storing the templates in a database, wherein the templates include data fields that can be filled by entering protocol data, the protocol data providing information about one or more elements of a protocol for the clinical trial;
downloading templates that have been filled with protocol data, from the database to one or more remote devices via a network;
prompting for the performance of at least one protocol element;
requesting performance data that contain information relating to any actual performance of one or more of the protocol elements; and
receiving the performance data and uploading the performance data from the remote devices onto the database.

2. A method in accordance with claim 1, wherein the protocol elements comprise behavioral elements, and wherein at least some of the protocol data contain information relating to expected behaviors or expected rates of behaviors by one or more participants of the trial protocol, and wherein at least some of the protocol data contain information relating to targeted time points by which one or behavioral elements are expected to be completed.

3. A method in accordance with claim 1, wherein the act of prompting for the performance of at least one protocol element comprises generating prompt messages that ask one or more users of the remote devices to perform at least one protocol element, and displaying the prompt messages on the remote devices.

4. A method in accordance with claim 1, further comprising the act of updating at least some of the protocol data contained in the downloaded templates, in accordance with at least some of the performance data received from the remote devices.

5. A method in accordance with claim 1, wherein the acts of downloading the templates from the database onto the remote devices, and uploading the performance data from the remote devices to the database comprises synchronizing the remote devices with the database.

6. A method in accordance with claim 1, further comprising the act of generating one or more reports using the performance data, the reports relating at least in part to the degree of adherence to the trial protocol by one or more participants of the protocol, wherein at least some of the reports include a comparison between the expected behavior of the protocol participants, as described by the protocol data, with the actual behavior of the protocol participants, as described by the performance data, and wherein at least some of the reports are generated at predetermined time intervals.

7. A method in accordance with claim 1, further comprising the act of recording the performance data in the remote devices.

8. A method in accordance with claim 1, wherein the act of requesting performance data comprises causing a list of possible responses to one or more queries to be displayed on a screen, and wherein receiving performance data comprises receiving one or more selected ones of the displayed list of possible responses.

9. A method in accordance with claim 1, further comprising the acts of converting the filled templates into configuration files before downloading the filled templates onto the remote devices, and storing the configuration files in the remote devices.

10. A method of monitoring performance of a clinical trial, the method comprising:
accessing a remote database to download therefrom one or more templates over a network, the templates include data fields that can be filled by entering protocol data that provide information about one or more elements of a protocol for the clinical trial;
causing prompt messages to be sent to one or more participants of the trial, the prompt messages alerting the participants that performance of at least one protocol element is necessary;
requesting from at least one participant performance data relating to actual performance, if any, by the participant of one or more protocol elements;
in response to receipt of the performance data, generating a periodic report that assesses how well the trial protocol is being adhered to.

11. A system for monitoring performance of a clinical trial, the system comprising:
a database configured to store therein a plurality of templates that include data fields which can be filled by entering protocol data, the protocol data containing information relating to one or more elements of a protocol for the clinical trial, the database being linked to one or more remote devices through a communications network; and
a controller configured to control access to the database, and to control communications between the database and the remote devices over the network;
wherein the controller is configured to cause one or more templates to be downloaded over the network to the remote devices when the templates have been filled with at least some protocol data, so that the remote devices can generate one or more prompt signals that prompt for performance of one or more protocol elements in accordance with the protocol data, and that request performance data relating to any actual performance of the protocol elements; and
wherein the controller is further configured to upload the performance data from the remote devices and to store the performance data in the database.

12. A system in accordance with claim 11, wherein the protocol elements comprise behavioral elements, and wherein at least some of the protocol data describe expected behaviors by one or more participants of the trial protocol, the participants comprising at least some users of the remote devices.

13. A system in accordance with claim 12, wherein the elements of the protocol comprise at least one of:
identifying and recruiting clinical sites;
training research personnel regarding protocol design and implementation;
recruiting, interviewing, and selecting protocol participants;
enrolling, treating, and monitoring patients;
recording data relating to staff performance at one or more clinical trial sites, or at one or more patient homes; and
wherein the elements of the protocol further comprise desired time points by which one or more of the protocol elements are targeted to be completed.

14. A system in accordance with claim 11, wherein the controller is further configured to generate reports from the performance data, the reports comparing actual adherence to the protocol elements, as shown by the performance data, versus desired adherence to the protocol elements, as shown by the protocol data.

15. A system in accordance with claim 11, wherein the controller is further configured to modify at least one template stored in the database upon receipt of the performance data, in accordance with at least some of the uploaded performance data.

16. A system in accordance with claim 11, wherein the controller is further configured to synchronize the database with the remote devices, when downloading the templates or uploading the performance data.

17. A machine-readable medium having stored therein instructions that, when executed by a computer, cause the computer to:
create a plurality of templates and store the templates in a database, wherein the templates include data fields into which protocol data can be entered, the protocol data containing information that relate to one or more elements of a protocol for a clinical trial;
entering at least some protocol data into one or more templates, and downloading the templates containing the protocol data from the database onto at least one remote device via a network, so that the remote device can generate and display prompt signals that ask for at least some of the protocol elements to be performed in accordance with the protocol data entered in the templates, and that request performance data relating to any actual performance of the protocol elements; and
upload the performance data from the remote device onto the database, and store the performance data in the database.

18. A computer system for monitoring clinical trial performance, the system comprising:
means for creating and storing in a database a plurality of templates that include data fields into which protocol data can be entered, the protocol data providing information regarding one or more elements of a clinical trial protocol;
means for downloading from the database onto one or more remote devices one or more templates into which protocol data have been entered;
means for generating and displaying prompt signals which prompt for the performance of at least some of the protocol elements, and which request performance data relating to any actual performance of one or more protocol elements;
means for uploading any received performance data from the remote devices onto the database, and storing the performance data in the database.

19. A monitoring apparatus for monitoring performance of a clinical trial, the apparatus comprising:
means for communicating with a remote database having stored therein a plurality of templates that include data fields into which protocol data can be entered, the protocol data providing information relating to one or more elements of a protocol for the clinical trial;
a memory, a display, and an input device; and
a controller configured to control access to the memory, to control display of messages on the display, and to control communications with the remote database;
wherein the memory stores a computer program which is executable by the controller to:
download from the remote database one or more templates into which at least some protocol data have been entered;
responsive to the protocol data, generate one or more prompt messages that prompt for the performance of one or more protocol elements, and that request performance data relating to any actual performance of the protocol elements;
display the prompt messages on the display; and
record and store in the memory any performance data received through the input device.

20. A monitoring apparatus in accordance with claim 19, wherein the apparatus comprises at least one of:
a Palm Pilot; a portable telephone; a mobile interactive pager; an interactive television; and a personal digital assistant.

21. A monitoring apparatus in accordance with claim 19, wherein the computer program is also executable by the controller to generate from the performance data at least one report that compared actual adherence to the protocol elements, as shown by the performance data, versus desired adherence to the protocol elements, as shown by the protocol data.

22. A machine-readable medium having stored therein instructions that, when executed by a computer, cause the computer to:
download from the remote database one or more templates into which at least some protocol data have been entered;
responsive to the protocol data, generate one or more prompt messages that prompt for the performance of one or more protocol elements, and that request performance data relating to any actual performance of the protocol elements;
display the prompt messages on the display; and
record and store in the memory any performance data received through the input device.
